(19) United States
(12) Patent Application Publication
(10) Pub. No.: US 2016/0019932 A1
(43) Pub. Date: Jan. 21, 2016

(54) SYSTEMS AND METHODS FOR GENERATING VIDEO

(71) Applicants: Patty Sakunkoo, San Jose, CA (US); Nathan Sakunkoo, San Jose, CA (US)

(72) Inventors: Patty Sakunkoo, San Jose, CA (US); Nathan Sakunkoo, San Jose, CA (US)

(21) Appl. No.: 14/805,192

(22) Filed: Jul. 21, 2015

Related U.S. Application Data
(60) Provisional application No. 62/027,208, filed on Jul. 21, 2014.

(51) Int. Cl. G11B 27/031; H04N 21/43; H04N 21/439

(52) U.S. Cl. CPC G11B 27/031; H04N 21/4394; H04N 21/4307

(57) ABSTRACT

The present disclosure provides methods for generating video with minimal user involvement. A method for generating a video comprises accessing an audio repository and retrieving audio and analyzing the audio to identify peaks that have a signal amplitude above a threshold. The time between identified peaks is the determined. Next, a set of images for use in generating the video is retrieved from an image repository. The video is then generated such that individual images of the set of images are transitioned at a transition time that is equal to the time between peaks.

### CROSS-REFERENCE

This application claims priority to U.S. Provisional Patent Application No. 62/027,208, filed Jul. 21, 2014, which is entirely incorporated herein by reference.

### BACKGROUND

Video is an electronic medium for the recording, copying and broadcasting of moving visual images. Video can have a frame rate, which is the number of pictures (or images) per unit time. In some examples, the frame rate of a video can range from six or eight frames per second (frame/s) to 120 or more frames per second.

Video can be generated and transmitted or transported in a variety of ways, such as broadcast as an analog or digital signal. Video can be analog or digital. Digital video may be a type of digital recording system that works by using a digital rather than an analog video signal. Analog video may be a video signal transferred by an analog signal.

### SUMMARY

The present disclosure provides systems and methods for generating video with reduced or minimal involvement from a user.

An aspect of the present disclosure provides a method for generating a video with little or minimal involvement from a user. The method can be implemented by a computer system (“system”) having a computer processor that is programmed or otherwise configured to generate video. The system can be an electronic device of a user, such as a mobile (or portable) electronic device. The electronic device can include an electronic display for playing the video.

The method can comprise accessing an audio repository and retrieving audio. Next, using a computer processor, the audio is analyzed to determine a time between peaks that have a signal amplitude above a threshold. The threshold can be determined by a user or by the system. Next, an image repository coupled to the computer processor is accessed and a set of images is retrieved. The set of images can include a plurality of images, such as at least 2, 3, 4, 5, 6, 7, 8, 9, 10, 20, 30, 40, 50, 100, 200, 300, 400, 500, 1000, 10000, 50000, or 100000 images. In a memory location coupled to the computer processor, a video can be generated for a user. The video is generated such that, upon playback, it sequentially transitions individual images of the set of images at a transition time that is equal to the time between peaks. The video can comprise at least a portion of the audio synchronized with the set of images.

In some cases, the time between peaks is averaged across a plurality of times between peaks, each of which peaks has a signal amplitude above the threshold. For example, the time between peaks is averaged across at least 2, 3, 4, 5, 6, 7, 8, 9, 10, 20, 30, 40, 50, or 100 times between peaks. Such times between peaks can be the same or different.

Another method for generating a video with minimal involvement from a user can comprise (a) retrieving audio from an audio repository, wherein the audio has an audio signal with peaks; (b) using a computer processor, analyzing the audio signal to determine a time between the peaks that have a signal amplitude above a threshold; (c) retrieving a set of images from an image repository coupled to the computer processor; and (d) in a memory location coupled to the computer processor, generating a video for the user, wherein the video sequentially transitions individual images of the set of images at a transition time that is substantially equal to the time between the peaks determined in (b).

In some embodiments, the threshold is determined by the user. In some embodiments, the method further comprises, prior to (b), (i) scanning the audio to identify at least two audio signals with amplitudes that exceed a signal limit, and (ii) identifying the signal limit as the threshold. In some embodiments, the threshold is stored in memory. In some embodiments, the set of images includes a plurality of images. In some embodiments, the video comprises at least a portion of the audio that is synchronized with the set of images.

In some embodiments, the time between the peaks is averaged across a plurality of times, each of which times having peaks with an audio signal amplitude above the threshold. In some embodiments, the time between the peaks is averaged across at least 10 times. In some embodiments, at least a subset of the plurality of times between the peaks is different.

In some embodiments, (a)-(d) are performed without any involvement from the user. In some embodiments, the method further comprises providing the video on an electronic device of the user. In some embodiments, the computer processor is part of the electronic device.

In some embodiments, the method further comprises presenting the video for review by the user and receiving an indication as to whether the user is satisfied with the video. In some embodiments, the method further comprises repeating (b)-(d) with a different threshold if the user is not satisfied with the video. In some embodiments, the different threshold is provided by the user.

Another aspect of the present disclosure provides a computer readable medium comprising machine executable code that, upon execution by one or more computer processors, implements any of the methods above or elsewhere herein.

A computer-readable medium can comprise machine executable code that, upon execution by one or more computer processors, implements a method for generating a video with minimal involvement from a user, the method comprising: (a) retrieving audio from an audio repository, wherein the audio has an audio signal with peaks; (b) using a computer processor, analyzing the audio signal to determine a time between the peaks that have a signal amplitude above a threshold; (c) retrieving a set of images from an image repository coupled to the computer processor; and (d) in a memory location coupled to the computer processor, generating a video for the user, wherein the video sequentially transitions individual images of the set of images at a transition time that is substantially equal to the time between the peaks determined in (b).

Another aspect of the present disclosure provides a system comprising one or more computer processors and a memory location coupled thereto. The memory location can comprise machine executable code that, upon execution by the one or more computer processors, implements any of the methods above or elsewhere herein.

A system for generating a video with minimal involvement from a user can comprise an audio repository that stores audio; an image repository that stores a set of images; and a computer processor coupled to the audio repository and image repository, wherein the computer processor is programmed to (i) retrieve the audio from the audio repository, wherein the audio has an audio signal with peaks, (ii) analyze the audio signal to determine a time between the peaks that have a signal amplitude above a threshold, (iii) retrieve the set of images from the image repository, and (iv) in a memory location coupled to the computer processor, generate a video for the user, wherein the video sequentially transitions individual images of the set of images at a transition time that is substantially equal to the time between the peaks determined in (ii).

In some embodiments, the computer processor is programmed to scan the audio to identify at least two audio signals with amplitudes that exceed a signal limit, and identify the signal limit as the threshold. In some embodiments, the video comprises at least a portion of the audio that is synchronized with the set of images. In some embodiments, the computer processor is programmed to average the time between the peaks across a plurality of times, wherein each of the times has peaks with an audio signal amplitude above the threshold.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a method for generating video;

FIG. 2 shows a computer system that is programmed or otherwise configured to implement any of the methods provided herein.

FIG. 3 shows another computer system that is programmed or otherwise configured to generate video;

FIG. 4 is a screenshot of a user interface (UI) that permits a user to provide an audio for use in determining a transition time for a video that is to be generated; and

FIG. 5 is a screenshot of a UI that permits the user to select a set of images for use in generating a video.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “video,” as used herein, generally refers to a sequence of images and in some cases audio. The audio may be synchronized with the images. Video can be an electronic medium for the recording, copying and broadcasting of moving visual images. Video can include a video clip.

The term “audio,” as used herein, generally refers to an electrical or other representation of sound. Audio can be digital audio, which can be a representation of sound in a form processed and/or stored by computers or other digital electronics (e.g., audio file). Examples of audio include voice and music.

The term “image,” as used herein, generally refers to an artifact that depicts or records visual perception, for example a two-dimensional or three-dimensional picture that has the same or similar appearance to one or more objects, such as one or more inanimate objects and/or persons. An image can be a photograph (“photo”).

The term “transition time,” as used herein, generally refers to the length of time in which individual images of a video are presented to a user upon video playback. The transition time can be the time that images in a video are sequentially transitioned. For example, at a transition time of 1 millisecond (“ms”), individual images are presented to a user for a period of 1 ms. The transition time of a video can be inversely related to the frame rate of the video, which is the number of still images per unit of time of video.

### Methods for Generating Video

The present disclosure provides methods and systems for creating video in a manner that is improved over other methods and systems present available. Methods provided herein can enable a user to create video with minimal, little or no involvement from the user.

In some current methods, a user generates a video by first selecting photos for use in generating the video. The user may optionally select audio for the video. The user then provides at least one constant number to set the timing of the video. The user may adjust the length by selecting an arbitrary length of the video or selecting the length for each photo. The user may select either a fixed time or manually select the length for each photo. Next, the video is generated and stored for future playback.

Such a method may require substantial user involvement. For instance, from a set of photos, the user has to specify the length of time for each photo, either directly or indirectly with the total length divided by the number of photos. In some cases, the user may arbitrarily determine at least one constant number, either specifying a specific fixed number for the total length of the video or for each photo, or selecting the length of each photo manually (e.g., iMovie, PicFlow), prior to generating the video. This leads to various issues, such as video that is generated based on parameters that are arbitrarily determined by a user, which may lead to inconsistencies across videos generated by the same user or by different users (e.g., users the same images). In addition, from a set of photos that may need to be combined to generate video, such methods may not enable users to seamlessly calculate the total length of the video and sequence the photos.

An aspect of the present disclosure provides a method for generating video. Such a method can be implemented by a computer system (“system”) comprising a computer processor that is programmed or otherwise configured to generate video, as described elsewhere herein. The system can be an electronic device of a user (e.g., Smart phone) comprising an electronic display. As an alternative or in addition to, the system can be a computer server that is coupled to the electronic device of the user.

In a first operation, the user employs the system to select a set of images from an image repository of the system to generate video. The video can be a video clip. For example, the user can select photographs from a photograph library of the system. In some cases, the user can sort the images manually or automatically by the system. For example, the user can use an image similarity analysis module of the system to automatically sort the images based on the similarity of the images to one another. In such a case, similar images (e.g., photographs) can be placed adjacent to one another. In an example, the system analyzes the images to identify images that are similar to one another or differ from one another by a set percentage, such as less than 10%, 5%, 4%, 3%, 2%, or 1%. Images that differ from one another by less than a set percentage may be deemed similar. Similar images can be positioned adjacent to one another.

Next, the user can select audio to accompany the images for the video. The audio can be an audio clip. The audio can be selected before or after the images are selected by the user.

Next, the user can be presented with a video compilation of the images transitioning from one image to the next image. The video compilation can be presented on an electronic device of the user. In some situations, however, the user may not be presented with the video compilation.

The video can be generated by the system using the video compilation. The video compilation can include a transition time, which can be the length of time that the images of the video transition from one image to another. Such transition time constant can be determined using audio selected by the user or by the system. For instance, the system can process audio (e.g., an audio file) and identify peaks in an audio signal associated with the audio. The system can then automatically synchronize the transition of the images with the peaks of the audio signal. The images can be transitioned at variable intervals and synchronized automatically with the audio. For example, image transition in the video can be synchronized with music beats.

In some cases, if audio is selected by the user or automatically by the system, the system reads and processes the audio. For example, a photo-sequencing controller of the system can read the audio and store the audio in memory. Next, the system can process the audio to identify signal amplitudes (e.g., peaks) in the audio. The system then determines which amplitudes to record. In some cases, if a given audio signal is below a threshold, the system continues scanning the audio and analyzing audio signals in the audio. If a given audio signal is greater than or equal to a threshold, the system records (e.g., in memory) the timing of that particular point in the audio and subsequently proceeds to read and check against the threshold until the end of the audio or until the number of amplitudes identified by the system exceeds the number of photographs selected to generated the video.

The threshold can be automatically selected by the system (e.g., using a default threshold). Alternatively or in addition to, the user can select or adjust the threshold.

Next, the images are sequenced at the transition time determined by the system. In some cases, the system provides the user with the ability to preview the video. The user can adjust the threshold and generate a new video to be previewed by the user. If the user is satisfied with the preview, then the user can request that the system convert the images and audio into video. The system can then make the video accessible to the user.

The transition time between images can be determined from audio, which can be provided by the user or by the system. Further, the transition time between images can be determined before or after audio has been selected. In some cases, the transition time between images is determined before images are selected by a user.

Once generated, the video can be presented on an electronic device of the user. The video can be presented in final form or for preview. The electronic device can be a mobile electronic device with a graphical user interface (GUI) for presenting the video to the user. The electronic device can be in network communication with a server that generates the video. As an alternative, the video is generated by the electronic device and presented on the electronic device.

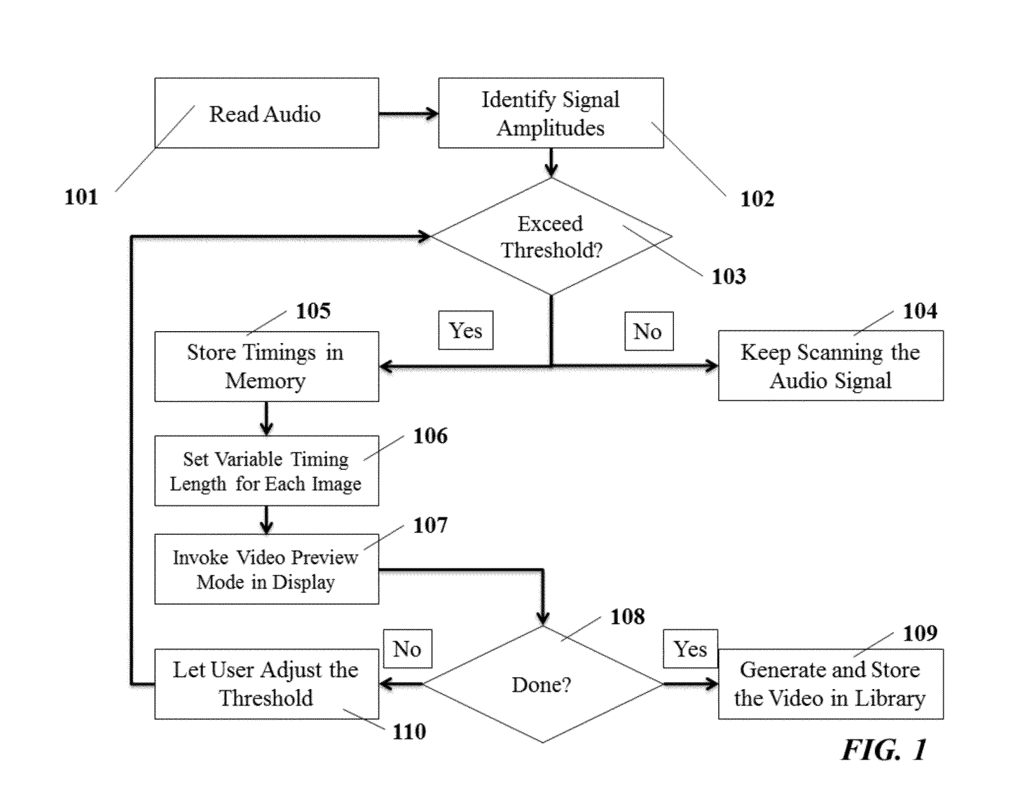

FIG. 1 shows another method for generating a video. In a first operation 101, an audio file is read by the system. Next, in a second operation 102, signal amplitudes are identified by the system. In a third operation 103, the system determines whether the signal amplitudes exceed a threshold. If the signal amplitudes (or peaks) do not exceed the threshold, then in a fourth operation 104 the system keeps scanning the audio for audio signals. If the signal amplitudes exceed the threshold, then in a fifth operation 105 the system stores a time between the signal amplitudes in memory. Next, in a sixth operation 106, the system sets a variable timing length for each image selected for use in generating the video. In a seventh operation 107, the system provides a preview of the video in an electronic display of the user. In an eighth operation 108, the system queries the user to determine whether the user is satisfied with the video. If the user is satisfied with the video, then the system stores the video in a video library. The user may access the video in the video library. If the user is not satisfied with the video, then in a ninth operation 109 the system can permit the user to select a different threshold.

In some cases, if in the third operation 103 the system does not identify signal amplitudes that exceed the threshold, then the system can query the user for a different threshold. Alternatively, the system can decrease the threshold until at least two signal amplitudes exceed the threshold. As another alternative, the threshold can be applied to the intervals between a pair of images. For example, the threshold can be such that no two images are closer together than 0.3 seconds, and hence an amplitude that is too close to the previous one will be skipped and not recorded.

Methods herein can be used to determine any transition time (or frame rate) from audio signals that exceed a threshold. In some cases, the determined transition time can be greater than or equal to about 0.1 milliseconds (“ms”), 1 ms, 2 ms, 3 ms, 4 ms, 5 ms, 10 ms, 20 ms, 30 ms, 40 ms, 50 ms, 100 ms, 1 second, 10 seconds, or 30 seconds. As an alternative, the determined transition time can be less than about 1 second, 100 ms, 50 ms, 40 ms, 30 ms, 20 ms, 10 ms, 5 ms, 4 ms, 3 ms, 2 ms, 1 ms, 0.1 ms, or 0.001 ms.

As an alternative or in addition to determining a transition time, a frame rate for a video can be determined by the system. The frame rate can be determined by identifying a number of images that are to be displayed per unit time upon playing a video. The frame rate can be the inverse of the transition time.

The system advantageously addresses the space and time issues of other current methods. In some cases, rather than showing all images to the user at once, the system sequences the images and displays them to the user sequentially on the electronic device of the user without user intervention. The system then generates and stores the video, for example on the electronic device of the user.

In some examples, the system can be implemented on the electronic device of the user. The electronic device can be a smartphone, for example, having software that implements video generation methods provided here. The software can be provided in a photo-sequencing tool, which generates a video, displays the video on an electronic display of the electronic device, and stores the video in a memory location of the electronic device. The tool can interact with a photograph library of the system, which can include executable instructions to store, organize, and present images (e.g., photographs). The tool can also interact with an audio library of the system, which can include executable instructions to store, organize, and present audio. The tool can also interact with a video library of the system, which can includes executable instructions to store, organize and present video.

### Computer Systems

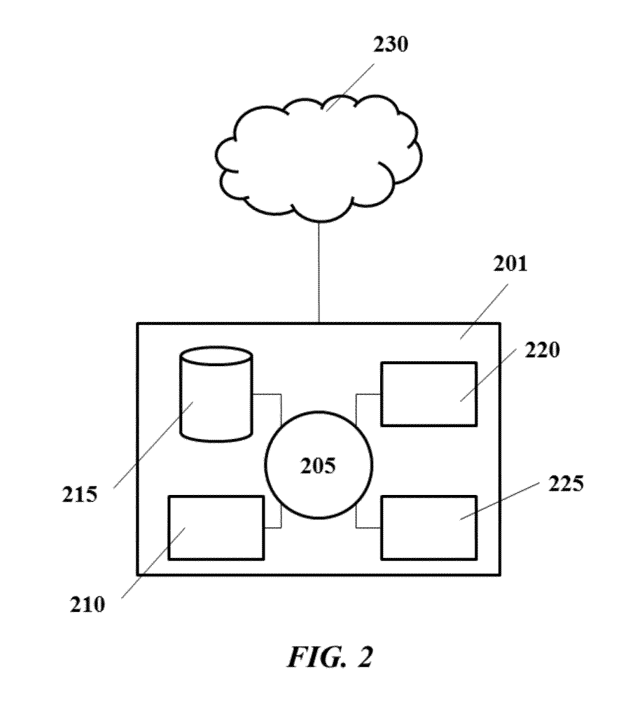

The present disclosure provides computer systems that are programmed to implement methods of the disclosure. FIG. 2 shows a computer system 201 that includes a central processing unit (CPU, also “processor” and “computer processor” herein) 205, which can be a single core or multi core processor, or a plurality of processors for parallel processing. The computer system 201 can be particularly tailored to implement methods provided herein. The computer system 201 also includes memory or memory location 210 (e.g., random-access memory, read-only memory, flash memory), electronic storage unit 215 (e.g., hard disk), communication interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communication bus (solid lines), such as a motherboard. The storage unit 215 can be a data storage unit (or data repository) for storing data. The computer system 201 can be operatively coupled to a computer network (“network”) 230 with the aid of the communication interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230, in some cases with the aid of the computer system 201, can implement a peer-to-peer network, which may enable devices coupled to the computer system 201 to behave as a client or a server.

The CPU 205 can execute a sequence of machine-readable instructions, which can be embodied in a program or software. The instructions may be stored in a memory location, such as the memory 210. Examples of operations performed by the CPU 205 can include fetch, decode, execute, and writeback. The instructions can be directed to the CPU 205, which can subsequently program or otherwise configure the CPU 205 to implement methods of the present disclosure.

The CPU 205 can be part of a circuit, such as an integrated circuit. One or more other components of the system 201 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The computer system 201 in some cases can include one or more additional data storage units that are external to the computer system 201, such as located on a remote server that is in communication with the computer system 201 through an intranet or the Internet.

The computer system 201 can communicate with one or more remote computer systems through the network 230. For instance, the computer system 201 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 201 via the network 230.

Methods as described herein can be implemented by way of machine (e.g., computer processor) executable code stored on an electronic storage location of the computer system 201, such as, for example, on the memory 210 or electronic storage unit 215. The machine executable or machine readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Methods and systems of the present disclosure can be implemented by way of one or more algorithms. An algorithm can be implemented by way of software upon execution by one or more computer processors.

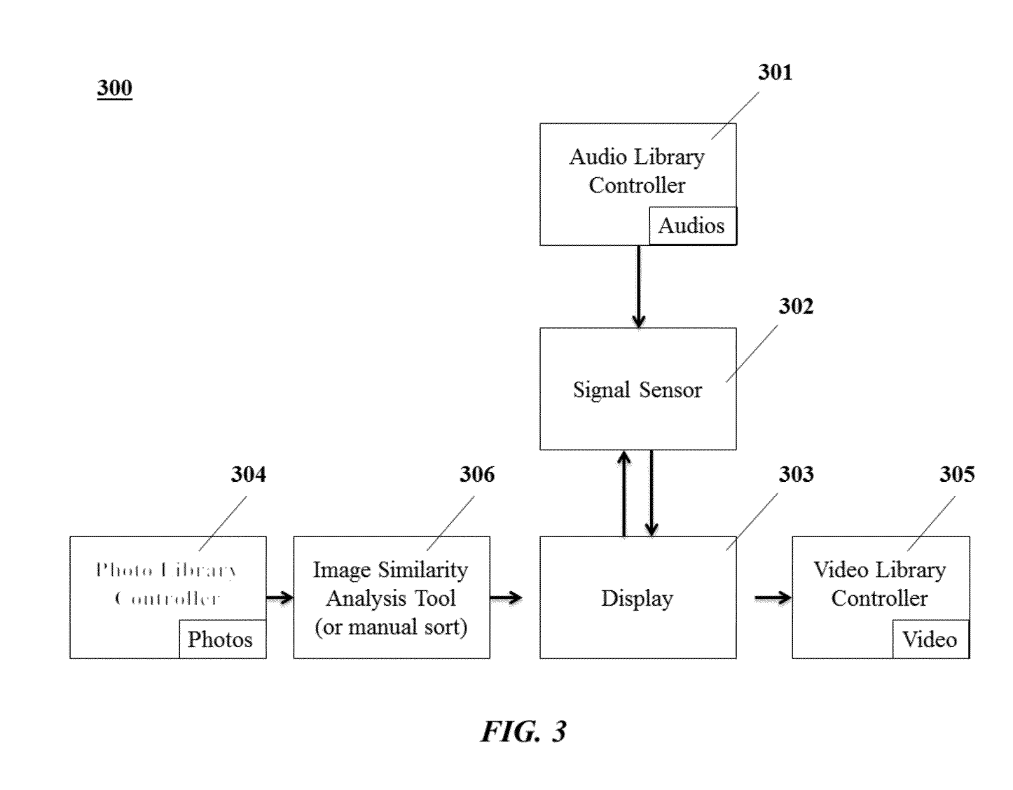

FIG. 3 shows another computer system 300 that is programmed or otherwise configured to generate video, as well as an example workflow for generating video using the computer system. The computer system can be a computer server that is in communication with an electronic device of a user. As an alternative, the computer system can be the electronic device of the user. As another alternative, a subset of the components of the computer system can be located on the computer server, and another subset or remainder of the components of the computer system can be located on an electronic device of the user.

The computer system can include various modules or controllers for implementing various operations of methods for generating a video, as disclosed herein. The system includes an audio library controller 301, which includes executable instructions to store, organize, and present audio. The audio library controller 301 directs audio to a signal sensor 302, which processes the audio and identifies signal amplitudes, which can be used to generate a transition time for the video. A display 303 shows a preview or final version of the video generated from the transition time, and enable the user to input another threshold if the video is not acceptable to the user.

The system 300 further comprises a photograph (photo) library controller 304, which includes executable instructions to store, organize, and present images (e.g., photos). The photo library controller 304 can interact with the audio library controller 301. The photo library controller 304 can also interact with a video library controller 305, which includes executable instructions to store, organize, and present videos once they have been generated.

The system 300 further comprises an image similarity analysis tool 306, which can be an automated sorter or a manual sorter. The image similarity analysis tool 306 accepts images from the photo library controller 304 and sorts the images automatically based, for example, on the similarity of the images. In some cases, the images similarity analysis tool 306 orders images such that similar photographs are placed adjacent to one another.

The user can use the audio library controller 301 to select an audio to accompany the video either before or after selecting photographs using the photo library controller 304.

Once a video has been generated and accepted by the user, the system can direct the video to the video library controller 305. The video library controller 305 can store, organize and make the video accessible by the user.

Computer systems of the present disclosure can include or be in communication with an electronic display that comprises a user interface (UI) for providing, for example, a set of images selected by the system or by the user for use in generating video; a threshold for use in selecting the transition time; a video preview; and the video. Examples of UI's include, without limitation, a graphical user interface (GUI) and web-based user interface.

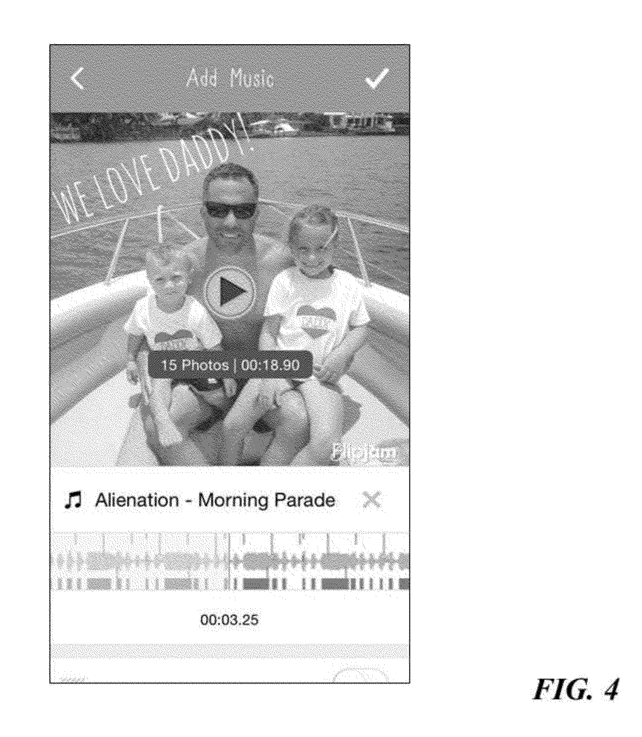

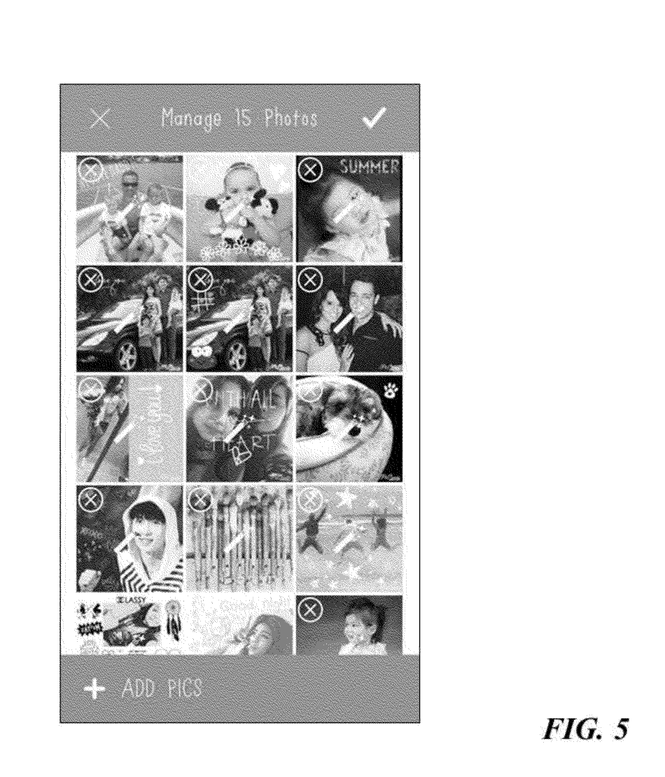

FIG. 4 is a screenshot of a UI that permits the user to provide an audio for use in determining a transition time for a video that is to be generated. A system of the present disclosure analyzes the audio and identifies peaks that have an amplitude above a threshold determined by the user or by the system. Before or after determining the transition time, the system can permit the user to select a set of images for use in generating the video, as shown in the screenshot of the UI of FIG. 5.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for generating a video with minimal involvement from a user, comprising:
(a) retrieving audio from an audio repository, wherein said audio has an audio signal with peaks;
(b) using a computer processor, analyzing said audio signal to determine a time between said peaks that have a signal amplitude above a threshold;
(c) retrieving a set of images from an image repository coupled to said computer processor; and
(d) in a memory location coupled to said computer processor, generating a video for said user, wherein said video sequentially transitions individual images of said set of images at a transition time that is substantially equal to said time between said peaks determined in (b).

2. The method of claim 1, wherein said threshold is determined by said user.

3. The method of claim 1, further comprising, prior to (b), (i) scanning said audio to identify at least two audio signals with amplitudes that exceed a signal limit, and (ii) identifying said signal limit as said threshold.

4. The method of claim 1, wherein said threshold is stored in memory.

5. The method of claim 1, wherein said set of images includes a plurality of images.

6. The method of claim 1, wherein said video comprises at least a portion of said audio that is synchronized with said set of images.

7. The method of claim 1, wherein said time between said peaks is averaged across a plurality of times, each of which times having peaks with an audio signal amplitude above said threshold.

8. The method of claim 7, wherein said time between said peaks is averaged across at least 10 times.

9. The method of claim 7, wherein at least a subset of said plurality of times between said peaks is different.

10. The method of claim 1, wherein (a)-(d) are performed without any involvement from said user.

11. The method of claim 1, further comprising providing said video on an electronic device of said user.

12. The method of claim 11, wherein said computer processor is part of said electronic device.

13. The method of claim 1, further comprising presenting said video for review by said user and receiving an indication as to whether said user is satisfied with said video.

14. The method of claim 13, further comprising repeating (b)-(d) with a different threshold if said user is not satisfied with said video.

15. The method of claim 14, wherein said different threshold is provided by said user.

16. A system for generating a video with minimal involvement from a user, comprising:
an audio repository that stores audio;
an image repository that stores a set of images; and
a computer processor coupled to said audio repository and image repository, wherein said computer processor is programmed to (i) retrieve said audio from said audio repository, wherein said audio has an audio signal with peaks, (ii) analyze said audio signal to determine a time between said peaks that have a signal amplitude above a threshold, (iii) retrieve said set of images from said image repository, and (iv) in a memory location coupled to said computer processor, generate a video for said user, wherein said video sequentially transitions individual images of said set of images at a transition time that is substantially equal to said time between said peaks determined in (ii).

17. The system of claim 16, wherein said computer processor is programmed to scan said audio to identify at least two audio signals with amplitudes that exceed a signal limit, and identify said signal limit as said threshold.

18. The system of claim 16, wherein said video comprises at least a portion of said audio that is synchronized with said set of images.

19. The system of claim 16, wherein said computer processor is programmed to average said time between said peaks across a plurality of times, wherein each of said times has peaks with an audio signal amplitude above said threshold.

20. A computer-readable medium comprising machine executable code that, upon execution by one or more computer processors, implements a method for generating a video with minimal involvement from a user, the method comprising:
(a) retrieving audio from an audio repository, wherein said audio has an audio signal with peaks;
(b) using a computer processor, analyzing said audio signal to determine a time between said peaks that have a signal amplitude above a threshold;
(c) retrieving a set of images from an image repository coupled to said computer processor; and
(d) in a memory location coupled to said computer processor, generating a video for said user, wherein said video sequentially transitions individual images of said set of images at a transition time that is substantially equal to said time between said peaks determined in (b).
